(19) United States
(12) Patent Application Publication
(10) Pub. No.: US 2008/0005362 A1
(43) Pub. Date: Jan. 3, 2008

(54) SATA odd block handling

(75) Inventor: Jim Wong, Monrovia, CA (US)

Correspondence Address: LAW OFFICE OF MARK J. SPOLYAR, 2200 CESAR CHAVEZ STREET, SUITE 8, SAN FRANCISCO, CA, 94124, US

(73) Assignee: Quantum Corporation

(21) Appl. No.: 11/402,239

(22) Filed: Apr. 11, 2006

(51) Int. Cl. G06F 3/00

(52) U.S. Cl. 710/5

(57) ABSTRACT

An exemplary embodiment provides for a data storage device that includes a transport layer operative to transfer data to, and receive data from, a host in frames comprising one or more words, each of the one or more words having a fixed, uniform number of data elements. Also included is an application layer operative to support odd-size blocks identified in read and write commands, wherein the number of identified data elements (modulo the fixed uniform number) does not equal 0, a storage medium and a controller. The controller is operative to discard, during a write operation, one or more fill data elements in a word associated with a write command identifying an odd-sized block prior to writing the data elements to the physical storage medium. The controller is also operative to add, during a read operation, one or more fill data elements in a word associated with a read command identifying an odd-sized block prior to assembly of a frame by the transport layer.

### BACKGROUND

Small computer system interface (SCSI) is a ubiquitous parallel interface standard used for data transfer, typically data transfer between a storage drive and a computer. Generally, the host system and target drive transfer data in segments or words having a fixed number of bytes, such as four bytes. Often, the number of bytes in the block of data to be transferred is not evenly divisible by the number of bytes of the segment or word supported by the host and target systems. Contained in the SCSI standard are provisions for “odd block” size transfers. In other words, the SCSI standard is capable of handling blocks of data where the number of bytes to be transferred (modulo transfer segment size) is greater than zero.

While the SCSI standard is a proven technology and has been utilized for a long period of time, new standards are emerging as alternatives to the SCSI standard. One such emerging standard is the serial ATA (“SATA”) protocol. However, SATA can not handle odd block sizes of data. As the SATA protocol becomes more widely adapted, situations may arise wherein it may be desirous to utilize a SATA-type drive that can handle odd block transfers.

In light of the foregoing, a need in the art exists for methods, apparatuses and systems that allow for, or facilitate, implementation of odd block size handling of data in SATA-type drives.

The foregoing examples of the related art and limitations related therewith are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, apparatuses and methods which are meant to be exemplary and illustrative, not limiting in scope. In various embodiments, one or more of the above-described problems have been reduced or eliminated.

One embodiment by way of non-limiting example provides for a data storage device that includes a transport layer operative to transfer data to, and receive data from, a host in frames comprising one or more words, each of the one or more words having a fixed, uniform number of data elements. Also included is an application layer operative to support odd-size blocks identified in read and write commands, wherein the number of identified data elements (modulo the fixed uniform number) does not equal 0, a storage medium and a controller. The controller is operative to discard, during a write operation, one or more fill data elements in a word associated with a write command identifying an odd-sized block prior to writing the data elements to the physical storage medium. The controller is also operative to add, during a read operation, one or more fill data elements in a word associated with a read command identifying an odd-sized block prior to assembly of a frame by the transport layer.

In addition to the exemplary aspects and embodiments described above, further aspects and embodiments will become apparent by reference to the drawings and by study of the following descriptions.

### BRIEF DESCRIPTION OF THE DRAWINGS

Exemplary embodiments are illustrated in referenced figures of the drawings. It is intended that the embodiments and figures disclosed herein are to be considered illustrative rather than limiting.

FIG. 1 is a block diagram illustrating a typical SATA drive which can be used to implement the claimed embodiments;

FIG. 2 is a simplified block diagram of a tape drive, in accordance with principles of the claimed embodiments, operatively connected within a host computing environment;

FIG. 3 illustrates typical driver stacks, part of which can be used to implement the claimed embodiments, of a host and a mass storage device, such as the SATA drive of FIG. 1, used for passing commands and data between the host the mass storage device;

FIG. 4 illustrates an exemplary SATA data frame;

FIG. 5 is a block diagram illustrating components of an SATA drive operable to process a SATA data frame, such as the SATA data frame of FIG. 4;

FIG. 6 is a flow chart diagram illustrating a method for disassembling an SATA data frame during a WRITE operation, in accordance with an exemplary embodiment; and

FIG. 7 is a flow chart diagram illustrating a method for assembling an SATA data frame during a READ operation, in accordance with an exemplary embodiment.

### DETAILED DESCRIPTION

The following embodiments and aspects thereof are described and illustrated in conjunction with systems, apparatuses and methods which are meant to be exemplary and illustrative, not limiting in scope.

The claimed embodiments contemplate systems, apparatuses and methods for implementing odd block-sized transfer in an SATA environment. This is accomplished by monitoring a transfer count associated with a READ or WRITE operation, as a block of data is transferred to and from a storage drive during READ and WRITE operations. For example, during a WRITE operation an odd sized block of data may be received. A host that sent the frame has already entered “fill or pad bytes” at the end of a data portion of the segment or word of a frame to ensure the data arrives in even block sizes. By monitoring the transfer count relating to a count of the actual data length that does not include the fill bytes, an SATA drive is operable to ignore those fill bytes. In a similar fashion, during a READ operation, an SATA drive will monitor a transfer count as data is read from a storage medium. If the last data segment does not result in an even block size, the drive is operable to insert fill bytes to make it an even block size. Again, this is accomplished, in part, by monitoring the transfer count relative to modulo word or segment size.

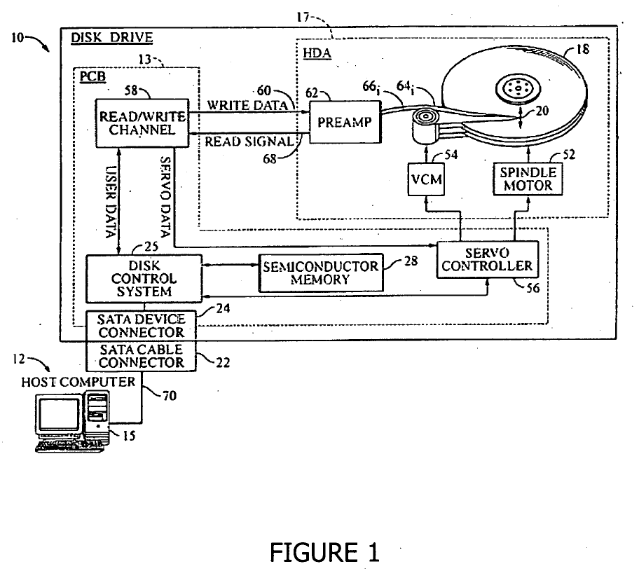

Before a thorough discussion of the claimed embodiments is discussed, FIGS. 1-5 will first be presented which describe functionalities of an SATA drive and an SATA frame. With reference to FIG. 1, FIG. 1 shows a block diagram of a system including a host computer 12 connected to an external SATA compatible disk drive 10. In this embodiment, the external SATA compatible disk drive 10 acts as the storage peripheral. It should be appreciated that the external SATA compatible disk drive 10 may be any type of storage drive, e.g., hard disk, 3.5 inch disk, CD ROM, ZIP, tape drive, etc.; but will be described as an exemplary external SATA compatible hard disk drive with reference to FIG. 1.

The external SATA compatible disk drive 10 includes a head disk assembly (HDA) 17 having a disk 18 and a transducer head 20 actuated radially over the disk. The external SATA compatible disk drive 10 further includes a disk control system 25, which may include a SATA interface (not shown), and a serial ATA (SATA) device connector 24. The disk control system 25 responds to disk-drive commands and accesses data storage locations on the disk 18 through the transducer head 20. The SATA device connector 24 couples the disk control system 25 to the host computer 12 when the external SATA compatible disk drive 10 is connected to the host computer 12 via a SATA compatible cable 70 and the SATA cable connector 22.

The HDA 17 of the SATA compatible disk drive 10 further includes a spindle motor 52 for rotating the disk 18 and a voice coil motor (VCM) 54 for actuating the transducer head 20 radially over the disk 18. A servo controller 56 generates the appropriate control signals applied to the spindle motor 52 and the VCM 54 in response to commands received from the disk control system 25. During a write operation the disk control system 25 transmits user data received from the host computer 12 to a READ/WRITE channel 58. The READ/WRITE channel 58 performs appropriate encoding of the user data to generate write data 60 written to the disk 18. The write data 60 modulates the operation of a preamp 62 to generate a write signal 64ᵢ applied to the head 20 in order to write magnetic transitions onto the surface of the disk 18. During a READ operation, the head 20 detects the magnetic transitions representing the recorded data to generate a read signal 66ᵢ which is amplified by the preamp 62 to generate a read signal 68 applied to the READ/WRITE channel 58. The READ/WRITE channel 58 demodulates the read signal 68 into user data transmitted to the host computer 12 via disk control system 25 after correcting errors.

The external SATA compatible disk drive 10 communicates with the host computer 12 over the SATA compatible cable 70 that includes a SATA cable connector 22 connected to the SATA device connector 24 using a communication protocol defined by an industry standard such as the Serial ATA standard 1.0.

The disk 18, spindle motor 52, VCM 54, preamp 62, and related hardware may be integrated into the HDA 17. The disk control system 25, SATA device connector 124, semiconductor memory 28, servo controller 56, READ/WRITE channel 58, and related electronics may be mounted on a printed circuit board (PCB) 13. The disk control system 25 generally includes circuitry and processors that control the HDA 17 and that provide an intelligent control interface between the host computer 12 and the HDA for execution of disk-drive commands. The disk control system 25 may have an internal microprocessor and nonvolatile memory for implementing some of the techniques of the claimed embodiments. The semiconductor memory 28 may have nonvolatile memory and volatile random access memory (RAM).

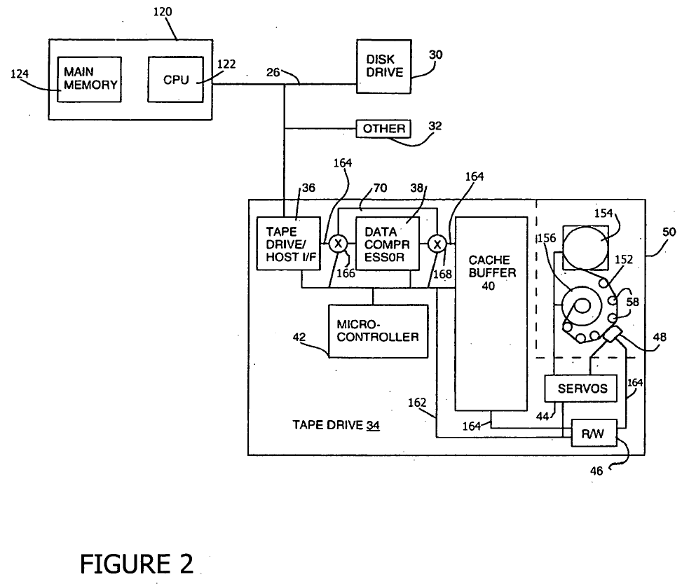

FIG. 2 represents an alternative, but still typical, computing environment, as compared to FIG. 1, for explaining principles of the claimed embodiments. In this example, a host computer 120 including at least a central processing unit (CPU) 122 and a main memory 124, communicates with peripheral computing equipment via an interface bus structure 26, which may be a broad-band parallel or serial bi-directional path, or other suitable interconnection. Peripherals may include a hard disk drive 30, other devices 32, such as printers, terminals, etc., and a tape drive 34.

The tape drive 34 includes a tape drive/host interface circuit 36 for connecting the tape drive 34 to the bus structure 26. The tape drive 34 also includes a data compressor circuit 38 operating in accordance with a conventional data compression and compaction algorithm, such as Lempel-Zev, type 1 (LZ1). The tape drive 34 includes a suitably sized cache buffer memory 40, which in this example may be a four megabyte solid state random access memory array including an array controller (not separately shown). The tape drive 34 includes a programmed microcontroller 42 for controlling the various circuit elements and processes as more fully explained hereinafter. The tape drive 34 also includes motor speed, tape tensioning, and head positioning servo circuitry 44, and a data read/write electronics channel 46 leading to a head structure 48 within a tape transport mechanism 50 (which is shown in FIG. 1 to be separated by dashed lines from the rest of the electronics circuitry of the tape drive 34).

Magnetic recording tape 152, supplied from e.g. a single feed reel cartridge 154, is spooled onto an internal take up reel 156 after having passed sinuously around a plurality of tape guide rollers 58 and past the head structure 48. In this example an automatic tape buckling mechanism, not shown and not particularly pertinent to an understanding of the present invention, enables coupling of the tape from the cartridge 154 to a leader attached to the take up reel 156.

The tape drive/host interface 36 is connected to the head structure 48 via an internal data path 164 which includes the data compressor 38, the cache buffer 40 and the read/write circuitry 46. In accordance with aspects of the present invention, two control nodes 166 and 168 span the data compressor 38 within the data path 164 and are interconnected by a bypass path 70, the function of which will be explained in greater detail hereinafter.

The microcontroller 42 is connected to an internal control bus structure 162 which enables the microcontroller 42 to monitor and control the tape drive/host interface circuit 36, the data compressor 38, the cache buffer 40, the servos circuitry 44, and the read/write channel electronics 46. The microcontroller 42 also controls the two control nodes 166 and 168 spanning the data compressor 38. It will therefore be appreciated that a user data record incoming from the host computer 120 (or disk drive 30) may be passed directly into the data compressor 38 and then into the cache buffer 40 in compressed format, or the data record may be passed directly into the cache buffer 40 without being compressed, in accordance with the states of the control nodes 166 and 168 spanning the data compressor 38 within the internal data path 164. Also, it should be appreciated that some process latency exists within the data compressor 38, so that some time elapses from the time an un-encoded user data record enters the compressor 38 until compressed data derived from the user data record completes exiting out of the compressor.

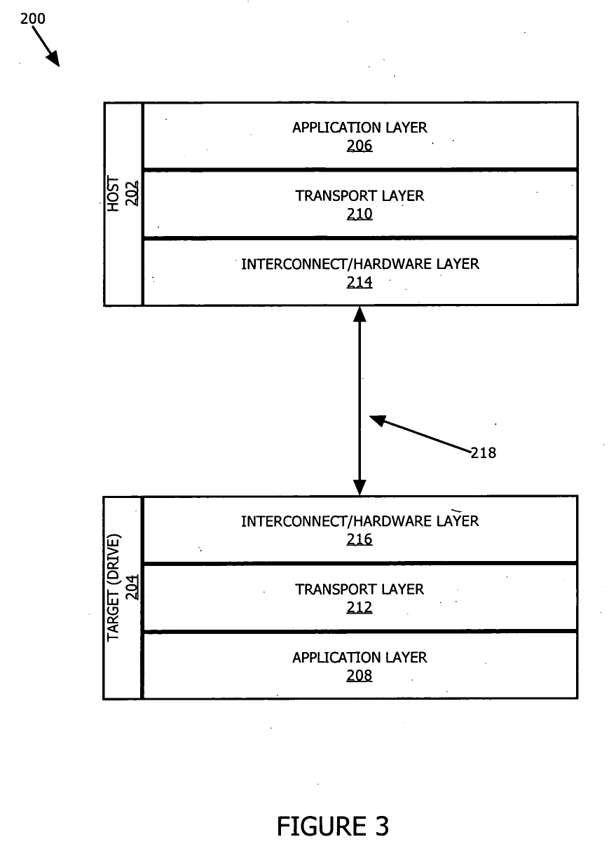

FIG. 3 illustrates typical driver stacks 200, part of which can be used to implement the claimed embodiments, of a host and a mass storage device, such as the SATA drive of FIG. 1, used for passing commands and data between the host the mass storage device. In essence, the stacks 200 receive generic commands, at either a drive or host computer, and then translate those generic commands to device-specific commands. Included in driver stacks 200 are a host-side driver stack 202 and a target/drive driver stack 204. Each stack 202 and 204 are further divided into application layers (206, 208), transport layers (210, 212) and interconnect/hardware layers (214, 216). Application layers (206, 208) are operative to present a command layer to an application at the host and drive, respectively. Restated, the application layers (206, 208) present a simplified interface to the drive and host such that they are capable of receiving simple commands (such as SCSI commands) such as READ or WRITE. The lower transport (210, 212), in turn, breaks down the simple commands into device-specific commands, as well as handling transport functions such as encapsulating data and/or commands into frames or other protocol data units. The interconnect layers (214, 216) generally involve processes associated with physically transferring commands and data between the host and target drive.

Once a simple command is received at either application layer (206, 208), the simple command is translated into a SCSI command which is in turn sent to the transport layer (210 or 212). The transport layer (210 or 212) includes information about communicating with particular types of devices and performs processes to transport commands and data between a host and a target. Some of these processes include encapsulating commands and data into SATA frames. Once the transport layer (210 or 212) has finished processing received commands, the processed commands are forwarded by the interconnect layer (214 or 216) via an appropriate bus to the actual device such as a target storage drive.

Typically, the application layers (206, 208) are implemented in software, the transport layers (210, 212) are implemented in hardware and software and the interconnect layers (214, 216) are implemented in hardware only. While the function of the stacks (202, 204) has been described in one direction, application to transport to interconnect, it should be understood that the process can go both ways for both stacks (202, 204). For example, to continue with the previous example, if a decomposed command is sent from the host interconnect later 214, via link 218, it is received at the drive interconnect layer 216 and is in turn translated to a form that can be understood by the drive, via layers 212 and 208.

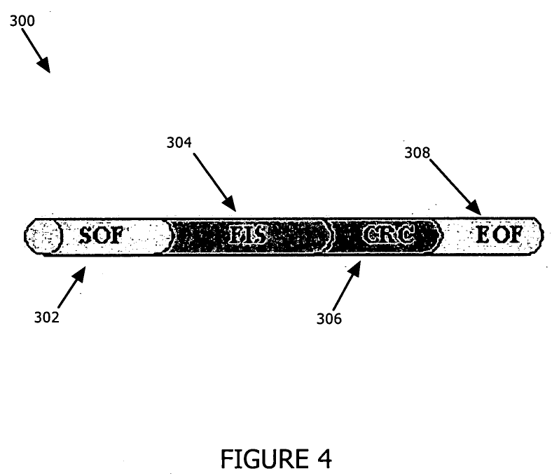

Turning to a description of an SATA frame that transport layers (210, 212) are operable to create and process, FIG. 4 illustrates an exemplary SATA frame 300. SATA frame 300 is typically employed to encapsulate a command (or data associated with the command), data transfer checks and delimiters to signal a beginning and an end of the frame. More specifically, SATA frame 300 includes a start of frame (“SOF”) section 302, a frame information structure (“FIS”) section 304, a cyclic redundancy code (“CRC”) section 306 and an end of frame (“EOF”) section 308. As their names imply, SOF 302 and EOF 308 merely mark a beginning and an end of a frame. The FIS 304 will typically contain command and other related data and the CRC 306 operates as a checksum to verify that all the data, contained in the FIS 304, was received intact. Typically, the FIS 304 of the SATA frame 300 is divided into “DWORDs” which are each four bytes long.

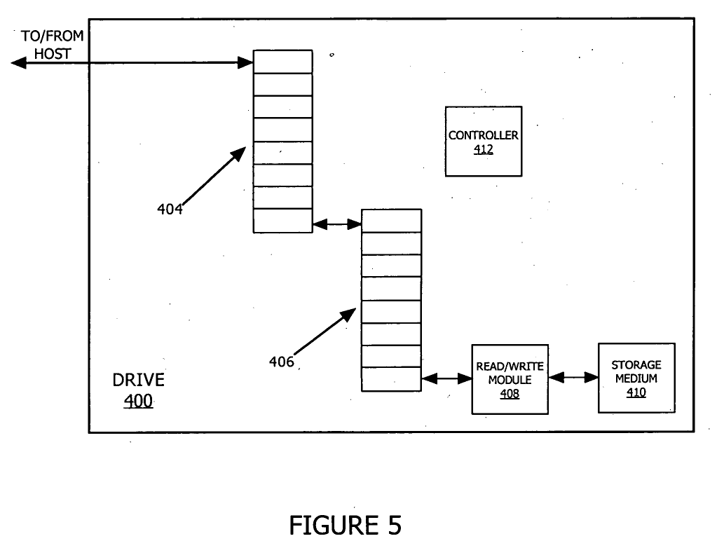

When an SATA frame is sent to a drive, for example, during a WRITE operation, it is received in a serial fashion as will be indicated via FIG. 5 which is a block diagram illustrating components of an SATA drive 400 operable to process an SATA frame, such as the SATA frame 300 of FIG. 4. Generally, an SATA frame is read a DWORD (four bytes) at a time into frame assembly/disassembly buffer 404. As buffer 404 begins to fill up, the controller 412 starts to read DWORDs in to ring buffer 406. Typically, a register size of the frame assembly/disassembly buffer 404 is 4 bytes long (DWORD) and a register size of the ring buffer is 32 bytes long (8 DWORDs). DWORDs processed through the ring buffer 406 are then sent to READ/WRITE module 408 which, in the WRITE direction, is operative to process one or more entries of the ring buffer, compress the received DWORDS, and write the compressed data to a storage medium 410. The above-described write operation is regulated by controller 412. A READ operation is processed in a similar manner to the WRITE operation except in a reverse manner. For example, data is sent from the storage medium 410 to the READ/WRITE module 408 where it is decompressed. The decompressed data is then processed through the ring buffer 406, the frame assembly/disassembly buffer 404 and the task file register 402.

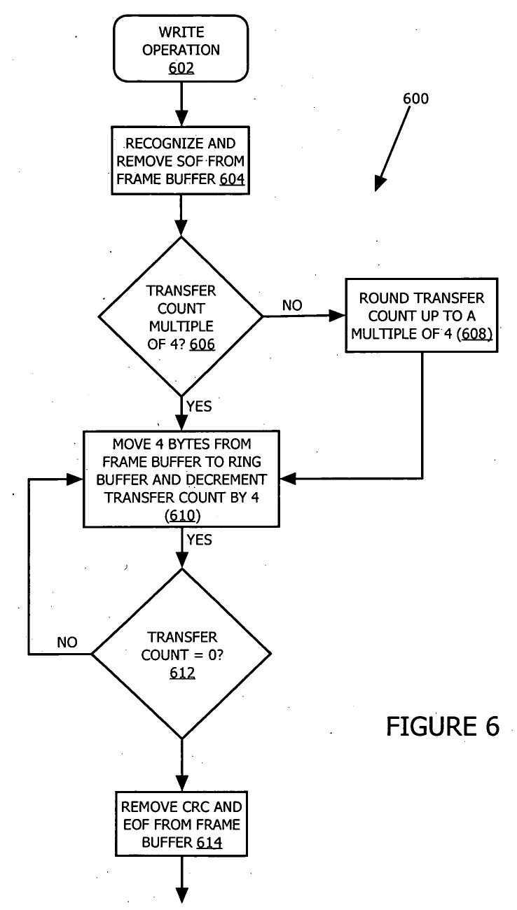

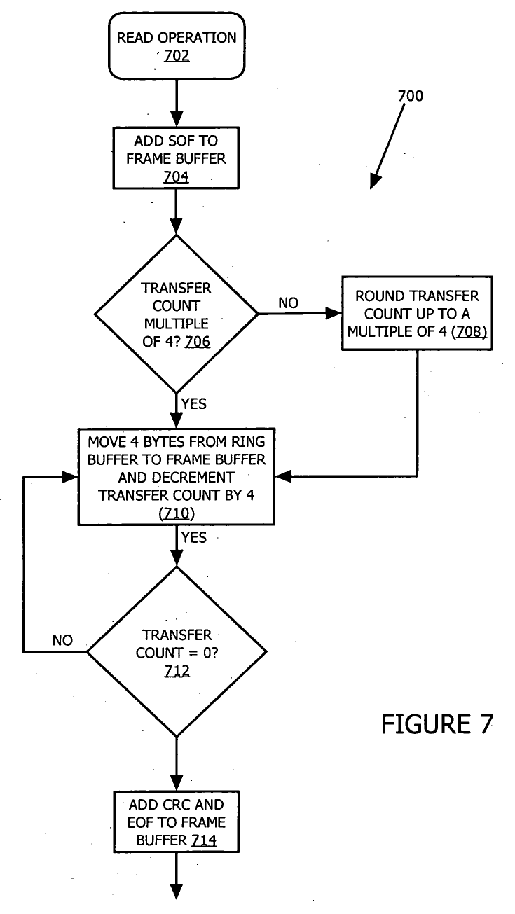

It should be noted that the above-described description of FIG. 5, and subsequent description of FIGS. 6A-7, applies to data FIS in a frame. The frame can also contain non-data FIS. When non-data FIS is encountered in frame buffer 404, that non-data FIS is routed to a task file register (not shown) and not the ring buffer 406. It should also be noted that the number of registers depicted in FIG. 5, for the ring buffer 406 and the frame assembly/disassembly buffer 404, is merely descriptive and is not meant to imply an actual number of registers in either buffer.

Now that FIGS. 1-5 have been fully described, the claimed embodiments will be further explored. As previously stated, the SATA protocol, at the hardware level, generally operates in DWORD (four bytes) chunks of data. To handle blocks of data, where at least one data segment (DWORD) is not four bytes long, fill bytes are inserted to create a complete data segment. Referring back to FIG. 3, SATA transport (210, 212) and interconnect layers (214, 216) can typically only handle DWORDs while a SCSI application layer (206, 208) supports READ and WRITE operations where transfer count (modulo DWORD) does not equal 0. In other words, SCSI application layer (206, 208) can handle odd sized blocks of data. In order to ensure that the transport and interconnect layers receive DWORDs, fill bytes are inserted or discarded, as necessary, in the last DWORD for READ and WRITE operations as described more fully below.

Generally, on the host side, one or more elements of the storage protocol stack is operative to add or discard fill bytes as required for READ and WRITE operations involving odd-size block transfers. In one implementation, for a WRITE operation, host application layer 206 is operative to add fill bytes to the last DWORD of a SATA frame, if transfer count (modulo 4 bytes) does not equal zero. For example, if the last DWORD only has two bytes, then two fill bytes will be added to complete the DWORD. For a READ operation, host application layer 206 is operative to discard/ignore fill bytes, as required, if transfer count (modulo 4 bytes) does not equal zero. Existing host-side storage protocol stacks known in the art are operative to pad and discard fill bytes as discussed above for odd-size block transfers. On the host side, the manner in, and the protocol layer at, which it is accomplished is not critical to the claimed embodiments.

At the drive, for example drive 400, the SCSI application layer 208 and the controller 412 are operative to handle READ and WRITE commands (CDBs) identifying odd-size blocks. While the transport layer 212 and interconnect layer 216 operate pursuant to a normal SATA configuration not recognizing that fill bytes have been added by the host system (during WRITE commands) or the controller 412 (during READ commands). During execution of a READ or WRITE command, the controller 412 initially sets a transfer count register based on the block size identified in the received command. As the READ or WRITE command is executed and the transfer count register is decremented, the controller 412 is operative to monitor the state of a transfer count register to determine whether to discard fill bytes to a DWORD before completion of a WRITE operation, or add fill bytes to a DWORD prior to completion of a READ operation. Given that the pad and discard operations are done at the hardware level, it is generally transparent to the transport and interconnect layers 212 and 216 of the drive protocol stack 204.

To more fully explain the WRITE and READ processes, FIGS. 6-7 will now be presented. FIG. 6 is a flow chart diagram illustrating a method 600 for disassembling an SATA data frame during a WRITE operation, in accordance with an exemplary embodiment. In general, a CDB transfer count of data segments going through frame assembly/disassembly buffer 404 is monitored by the SCSI application layer 208 and the controller 412. If the last data segment of a frame does not contain four bytes, then the drive 400 will know to ignore fill bytes that were inserted into that last data segment. For example, if the remaining CDB transfer count is two, then there will be two fill bytes to ignore as the register size of the frame assembly/disassembly buffer 404 is 4 bytes long. Another way of expressing this idea is that the transfer count is not modulo(4). That is, if there is a remainder from a [(transfer count)modulo(4)] operation, then fill bytes are present. Restated, if a remainder results from dividing the transfer count by 4, then fill bytes are present.

During a WRITE operation (602), the controller 412 recognizes and removes an SOF of a frame from the frame assembly/disassembly buffer 404 (604). Next, the controller 412 determines if a transfer count of the frame is a multiple of 4 (606). If no, the controller 412 and SCSI application layer 208 will round the transfer count up to a multiple of 4 (608). After the transfer count has been rounded up to a multiple of 4 (608) or if the transfer count is a multiple of 4, the controller 412 removes 4 bytes from the frame assembly/disassembly buffer 404 to the ring buffer 406 and decrements the transfer count by 4 (610). The controller 412 then repeats operation 610 until the transfer count is 0 (612). Next, the controller 412 removes the CRC and EOF of the frame from the frame assembly/disassembly buffer 404 (614).

A read process generally involves a read module, such as read module 408, reading compressed data from the storage medium 410 into a group buffer (not shown in Figures) of 4-byte segments. The read module 408 then decompresses the data and reads the data into the ring buffer 406 in 32-byte segments. An FIS assembly process (implemented by controller 412) reads the data into the frame assembly/disassembly buffer 404 (DWORDs) to construct the SATA frame. The FIS assembly process also involves content from a task file register (not shown) to assemble the FIS portion of the frame. FIG. 7 illustrates a process implemented by the controller during FIS assembly and when packets read from ring buffer onto frame assembly/disassembly buffer 404.

During a READ operation (702), the controller 412 adds an SOF to the frame assembly/disassembly buffer 404 (704). Next, the controller 412 determines if a transfer count of the frame is a multiple of 4 (706). If no, the controller 412 and SCSI application layer 208 will round the transfer count up to a multiple of 4 (708). After the transfer count has been rounded up to a multiple of 4 (708) or if the transfer count is a multiple of 4, the controller 412 moves 4 bytes from the ring buffer 406 to the frame assembly/disassembly buffer 404 and decrements the transfer count by 4 (710). The controller 412 then repeats operation 710 until the transfer count is 0 (712). Next, the controller 412 adds the CRC and EOF of the frame to the frame assembly/disassembly buffer 404 (714).

While FIGS. 5-7 are described in terms of a specific architecture and methods related to that architecture, it should be understood that the claimed embodiments can be practiced on other architectures. For example, an architecture that does not involve a ring buffer.

Advantageously, the claimed embodiments provide for odd block sized transfers in an SATA environment. Additionally, the claimed embodiments can be applied to an existing SATA drive through, for example, a driver update. While the claimed embodiments have been described in terms of a DWORD/modulo 4-type aspect, it should be understood that those claimed embodiments are not meant to be limited to that particular situation and that the claimed embodiments can function with other word lengths that may require padding or discarding of bytes.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A data storage device comprising:
a transport layer operative to transfer data to, and receive data from, a host in frames comprising one or more words, each of the one or more words having a fixed, uniform number of data elements;
an application layer operative to support odd-size blocks identified in read and write commands, wherein the number of identified data elements (modulo the fixed uniform number) does not equal 0;
a storage medium; and
a controller operative to:
discard, during a write operation, one or more fill data elements in a word associated with a write command identifying an odd-sized block prior to writing the data elements to the physical storage medium; and
add, during a read operation, one or more fill data elements in a word associated with a read command identifying an odd-sized block prior to assembly of a frame by the transport layer.

2. The data storage device as recited in claim 1 wherein the one or more data elements are bytes.

3. The data storage device as recited in claim 1 wherein the transport layer is a SATA transport layer.

4. The data storage device as recited in claim 1 further comprising an interconnect layer operative to transmit frames to, and receive frames from a host device.

5. The data storage device as recited in claim 4 wherein the interconnect layer is a SATA interconnect layer.

6. The data storage device as recited in claim 1 wherein the application layer comprises a SCSI application layer.

7. A data storage device operative to modify data segments during a WRITE command, the data storage device comprising:
a frame assembly/disassembly buffer operative to receive and forward the data segments;
a ring buffer operative to receive the data segments from the frame assembly buffer and operable to forward the data segments; and
a controller operative to:
discard one or more fill data elements in a word associated with the WRITE command identifying an odd-sized block prior to writing the data elements to a physical storage medium.

8. The data storage device as recited in claim 7 wherein the one or more fill data elements are bytes.

9. The data storage device as recited in claim 7 wherein a number of fill data elements to discard is based on a transfer count of the WRITE command.

10. The data storage device as recited in claim 9 wherein the number of fill bytes to discard is determined by a difference between the register size of the frame assembly/disassembly buffer and a remaining value of the transfer count.

11. The data storage device as recited in claim 1 further comprising a protocol stack that includes an application layer, a transport layer and an interconnect layer wherein the application layer is operative to discard the one or more fill elements in conjunction with the controller.

12. A data storage device operative to modify data segments during a READ command, the data storage device comprising:
a ring buffer operative to receive and forward the data segments;
a frame assembly buffer operative to receive the data segments from the ring buffer and forward the data segments; and
a controller operative to:
add one or more fill data elements in a word associated with the READ command identifying an odd-sized block prior to assembly of a frame.

13. The data storage device as recited in claim 12 wherein the one or more fill data elements are bytes.

14. The data storage device as recited in claim 12 wherein a number of fill data elements to add is based on a transfer count of the READ command.

15. The data storage device as recited in claim 14 wherein the number of fill bytes to add is determined by a difference between the register size of the ring buffer and a remaining value of the transfer count.

16. The data storage device as recited in claim 12 further comprising a protocol stack that includes an application layer, a transport layer and an interconnect layer wherein the application layer is operative to add the one or more fill bytes in conjunction with the controller.

17. A data storage device operative to modify data segments during a READ or WRITE command, the data storage device comprising:
a ring buffer operative to forward and receive data segments to and from a frame assembly buffer;
the frame assembly buffer operative forward and receive the data segments to and from the ring buffer; and
a controller operative to:
discard one or more fill data elements in a word associated with the WRITE command identifying an odd-sized block prior to writing the data elements to a physical storage medium; and
add the one or more fill data elements in a word associated with the READ command identifying an odd-sized block prior to assembly of a frame.

18. In a data storage device operative to modify data segments during a READ or WRITE command, a method comprising:
discarding, during the WRITE command, one or more fill data elements in a word associated with the WRITE command identifying an odd-sized block prior to writing the data elements to a physical storage medium; and
adding, during the READ command, the one or more fill data elements in a word associated with the READ command identifying an odd-sized block prior to assembly of a frame.

19. A system comprising:
a host system that includes a device driver comprising instructions operative to cause a programmable processor to:
add one or more fill data elements in a word associated with a WRITE command identifying an odd-sized block; and
discard the one or more fill data elements in a word associated with a READ command identifying an odd-sized block prior to assembly of a frame; and
a target drive operative to:
discard the one or more fill data elements in a word associated with the WRITE command identifying an odd-sized block prior to writing the fill data elements to a physical storage medium; and
add the one or more fill data elements in a word associated with the READ command identifying an odd-sized block prior to assembly of the frame.
